(19) United States
(12) Patent Application Publication
(10) Pub. No.: US 2023/0420773 A1
(43) Pub. Date: Dec. 28, 2023

(54) BATTERY PACKAGING MATERIAL

(71) Applicant: Resonac Packaging Corporation, Hikone-shi (JP)

(72) Inventors: Yuuji MINAMIBORI, Hikone-shi (JP); Makoto KARATSU, Hikone-shi (JP)

(73) Assignee: Resonac Packaging Corporation, Hikone-shi (JP)

(21) Appl. No.: 18/212,724

(22) Filed: Jun. 22, 2023

(30) Foreign Application Priority Data
Jun. 23, 2022 (JP) 2022-100857
May 16, 2023 (JP) 2023-080761

(51) Int. Cl. H01M 50/197; H01M 50/193; H01M 50/342; H01M 50/375

(52) U.S. Cl. CPC H01M 50/197; H01M 50/193; H01M 50/3425; H01M 50/375

(57) ABSTRACT

Provided is a battery packaging material in which the seal strength gradually decreases as the temperature rises, resulting in a gradual unsealing. The battery packaging material is composed of a substrate layer 13 served as an outer layer, a sealant layer 20A served as an inner layer, and a barrier layer 11 arranged between these two layers. The sealant layer 20A is composed of one or more layers. A first sealant layer 21 served as the innermost layer is made of a resin blend containing a polyolefin resin A having a melting point of 120° C. or above and a polyolefin resin B having a melting point of less than 120° C.

### TECHNICAL FIELD

The present invention relates to a battery packaging material suitably used as a case for a secondary battery for use in, e.g., an automobile, a stationary energy storage, a notebook computer, a cellular phone, and a camera, especially suitably used as a case for a small portable lithium-ion secondary battery.

### BACKGROUND ART

It has become possible for a battery storage device exemplified by a lithium-ion secondary battery to be processed from a can or a case into a variety of shapes by using a laminate-type packaging material in which a resin layer is laminated on both surfaces of an aluminum foil, which also makes it possible to make a battery storage device thinner and lighter. In a power storage device using a laminate material as a packaging material, when the battery internal temperature increases as the capacity of the device increases, a gas is generated due to electrolyte volatilization, etc., causing the increased internal pressure to expand the case or causing a rupture of the case. There is also a risk of ignition if the gas is flammable. For this reason, a countermeasure is taken for the device to prevent a rupture of the case by allowing gradual gas release (see Patent Documents 1 to 3).

As a safety standard for ignition, there is, for example, JIS C8714 (2007) “Safety tests for portable Lithium Ion secondary cells and batteries for use in portable electronic applications.” In this safety test, the temperature is raised to 130° C.±2° C. at 5±2° C./minute and held for 10 minutes to confirm that it does not cause ignition or rupture, thereby ensuring the safety of the battery. A battery that has passed the above-described safety test does cause peeling of the seal portion of the case within a normal operating temperature range, thus ensuring safety. On the other hand, when the temperature rises excessively, the gas generated from the battery body raises the internal pressure of the case, but when the temperature exceeds a certain level, the seal portion is unsealed and the case is unsealed, allowing the gas to escape out of the case, which prevents the case from rupturing due to the rise in the internal pressure.

The preventive measure described in Patent Document 1 is based on the structure of the case, and Patent Document 1 discloses a valve mechanism for reducing the pressure in the case when the pressure rises and a ventilation channel for directing the gas in the case to the valve mechanism.

Patent Document 2 and Patent Document 3 described above disclose a technology of unsealing the case at high temperatures by defining the battery packaging material. Patent Document 2 discloses to a technology for unsealing the case when the heat-fusible resin layer (sealant layer) is exposed to a high-temperature environment of about 90° C. to 120° C. by specifying the melting peak temperature of the heat-fusible resin layer. Furthermore, Patent Document 3 discloses a technology for unsealing the case at high temperatures by specifying the heat-seal strength between heat-fusible resin layers.

### PRIOR ART DOCUMENT

### Patent Document

Patent Document 1: Japanese Patent No. 6540871
Patent Document 2: Japanese Patent No. 7019991
Patent Document 3: WO 2021/201293 A1

### SUMMARY OF INVENTION

### Problem to be Solved by the Invention

However, the preventive measure described in Patent Document 1 requires additional components, such as, e.g., a valve mechanism and a ventilation channel, and therefore, the material cost and the production cost increase. Although Patent Document 2 and Patent Document 3 do not require an additional component, such as, e.g., a valve device, when exposed to high temperatures, the seal strength suddenly decreases to unseal the seal portion, which may cause gas ejection.

### Means for Solving the Problems

In view of the above-described Background Art, the present invention provides a battery packaging material in which the seal strength gradually decreases as the temperature rises, resulting in gradual unsealing of the packaging case.

That is, the present invention has the configurations described in the following Items [1] to [6].
[1] A battery packaging material comprising:
   a substrate layer served as an outer layer;
   a sealant layer served as an inner layer;
   a barrier layer arranged between the substrate layer and the sealant layer,
   wherein the sealant layer is composed of one or more layers, and
   wherein a first sealant layer served as an innermost layer is made of a resin blend containing a polyolefin resin A having a melting point of 120° C. or above and a polyolefin resin B having a melting point of less than 120° C.
[2] The battery packaging material as recited in the above-described Item [1],
   wherein in the resin blend, the polyolefin resin A and the polyolefin resin B are compatible with each other.
[3] The battery packaging material as recited in the above-described Item [1] or [2],
   wherein the polyolefin resin A contains at least one of a propylene-ethylene random copolymer, a propylene-butene random copolymer, a propylene-ethylene-butene random copolymer, a propylene (metallocene-based propylene) prepared using a metallocene catalyst, and a propylene compound (metallocene-based propylene compound) prepared using a metallocene catalyst, and
   wherein the polyolefin resin B contains at least one of a propylene-ethylene copolymer and a propylene-α-olefin copolymer.
[4] The battery packaging material as recited in any one of the above-described Items [1] to [3],
   wherein the sealant layer is a multiple layer composed of the first sealant layer, a second sealant layer composed of at least one layer or more, and a third sealant layer in sequence from an inner side of the battery packaging material toward the barrier layer, and
   wherein the at least one layer of the second sealant layer and the third sealant layer are made of a polyolefin resin having a melting point of 130° C. or above.
[5] The battery packaging material as recited in the above-described Item [4],
   wherein the polyolefin resin having a melting point of 130° C. or above contains at least one of a propylene-ethylene random copolymer, a propylene-butene random copolymer, and a propylene-ethylene-butene random copolymer.
[6] The battery packaging material as recited in any one of the above-described Items [1] to [5],
   wherein a total amount of the polyolefin resin A and the polyolefin resin B in the first sealant layer is 90 mass % to 99.9 mass % of a resin constituting the first sealant layer, and
   wherein a mass ratio of the polyolefin resin A to the polyolefin resin B is 20:80 to 80:20.
[7] The battery packaging material as recited in any one of the above-described Items [1] to [5],
   wherein a total amount of the polyolefin resin A and the polyolefin resin B in the first sealant layer is 90 mass % to 99.9 mass % of a resin constituting the first sealant layer, and
   wherein a mass ratio of the polyolefin resin A to the polyolefin resin B is 30:70 to 50:50.
[8] The battery packaging material as recited in the above-described Item [7],
   wherein the polyolefin resin A contains polypropylene (metallocene-based propylene) using a metallocene catalyst.

### Effects of the Invention

According to the battery packaging material described in the above-described Item [1], the first sealant layer of the sealant layer is made of a resin blend containing the polyolefin resin A having a melting point of 120° C. or above and the polyolefin resin B having a melting point of less than 120° C. Therefore, the seal strength is maintained at temperatures of 100° C. or below, and the polyolefin resin B having a low melting point softens at temperatures over 100° C. up to 130° C. earlier than the polyolefin resin A. Therefore, the seal strength gradually decreases. For this reason, the seal portion of the battery case is gradually unsealed to discharge the gas, thus preventing the case rupturing.

According to the battery packaging material as described in the above-described Item [2], the polyolefin resin A and the polyolefin resin B, which constitute the first sealant layer of the sealant layer, are compatible and, therefore, due to the properties of both the resins, a high seal strength can be maintained at temperatures of 100° C. or below, and a gradual unsealing effect can be sufficiently obtained until it reaches the temperature of 130° C.

According to the battery packaging material as recited in the above-described Item [3], since high compatibility can be achieved by the combination of the polyolefin resin A and the polyolefin resin B specified as described above, a high seal strength can be maintained at temperatures of 100° C. or below, and the gradual unsealing effect can be fully obtained before reaching to the temperature of 130° C.

According to the battery packaging material described in the above-described Item [4], a resin layer having a higher melting point is arranged as the second sealant layer and the third sealant layer arranged on the outside of the first sealant layer which comes into contact a first sealant layer of another battery packaging material during the heat sealing, so that the case can be securely unsealed by delaminating at the first sealant layer when the temperature rises. Consequently, the unsealing timing can be precisely controlled to prevent rupturing of the case. Further, the sealant layer can be made thinner because the presence of the second and third sealant layers having a higher melting point on the outside prevents the wall thickness reduction of the sealant layer due to heat sealing. Furthermore, the sealing performance of the portion from which the tub leads are drawn out can be improved.

According to the battery packaging material described in the above-described Item [5], the use of the specified resin for the second sealant layer 22 and the third sealant layer 23 will prevent delamination in the sealant layers and ensure the seal strength at temperatures of 100° C. or below.

According to the battery packaging material described in the above-described Item [6], the mixing ratio of two resins with different melting points allows the material to maintain a high seal strength at temperatures of 100° C. or below and to fully achieve the gradual unsealing effect until it reaches the temperature of 130° C. or below.

According to the battery packaging material described in the above-described Item [7], the polyolefin resin B having a lower melting point is contained more than the polyolefin resin A, which enables gradual unsealing until it reaches a temperature of 130° C.

According to the battery packaging material described in the above-described Item [8], it is possible to secure the seal strength at room temperature and obtain a seal strength in which unsealing starts gradually at 100° C. and can be assuredly performed at 130° C.

### BRIEF DESCRIPTION OF DRAWINGS

FIG. 1 is a cross-sectional view showing one example of a battery packaging material according to the present invention.

FIG. 2 is a cross-sectional view showing another example of a battery packaging material according to the present invention.

FIG. 3 is a cross-sectional view showing yet another example of a battery packaging material according to the present invention.

FIG. 4 is a cross-sectional view showing a battery provided with a battery case made of the battery packaging material shown in FIG. 1 to FIG. 3.

### EMBODIMENTS FOR CARRYING OUT THE INVENTION

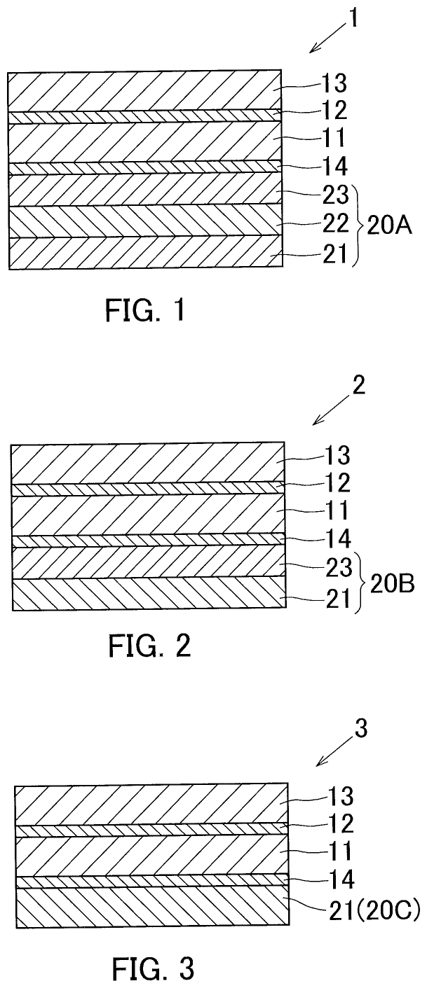

FIG. 1 to FIG. 3 show three embodiments of the battery packaging materials according to the present invention.

In the following description, a layer assigned by the same reference symbol represents the same or equivalent layer, and the duplicate description thereof will be omitted.

In the battery packaging materials 1, 2, and 3, a substrate layer 13 is adhered to one surface of a barrier layer 11 via a first adhesive layer 12, and sealant layers 20B, and 20C are adhered to the other surface of the barrier layer 11 via a second adhesive layer 14.

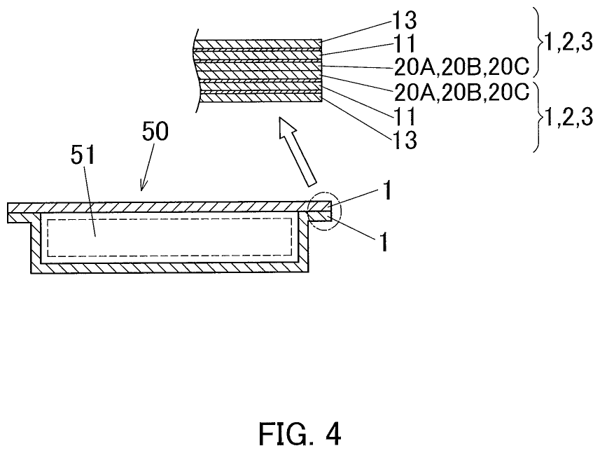

As shown in FIG. 4, a battery case 50 using the battery packaging materials 1, 2, and 3 described above is produced by placing the sealant layers 20A, 20B, and 20C to face each other and heat-sealing around the battery packaging materials 1, 2, and 3. A bare cell 51 is sealed inside the battery case 50. In the produced battery case 50, the substrate layer 13 is served as an outer layer, and the sealant layer 20A, 20B, and 20C is served as an inner layer. In the present invention, when describing the position of each layer constituting the battery packaging materials 1, 2, and 3 in terms of direction, the direction toward the substrate layer 13 is referred to as outside, and the direction toward the sealant layers 20A, 20B, and 20C is referred to as inside.

### (Configuration of Sealant Layer)

The battery packaging material of the present invention is characterized by the material of the sealant layer serving as an inner layer. The sealant layer provides the battery packaging materials 1, 2, and 3 with excellent chemical resistance to corrosive electrolytes, etc., and also provides heat-sealing properties.

The sealant layer is composed of one or more layers and may be composed of either a single layer or a multiple layer. The material of the sealant layer served as the innermost layer of the battery packaging material, i.e., the layer that comes into contact with each other when the battery packaging materials placed to face with each other are heat-sealed, is specified, and if necessary, the materials of the layers other than the first sealant layer are also specified.

The sealant layer 20A of the battery packaging material 1 shown in FIG. 1 has a three-layer structure in which the first sealant layer 21, the second sealant layer 22, and the third sealant layer 23 are laminated in order from the inner side of the battery packaging material 1 to the barrier layer 11 side. The first sealant layer 21 is an innermost layer of the battery packaging material 1, farthest from the barrier layer 11, the third sealant layer 23 is a layer closest to the barrier layer 11 and in contact with the second adhesive layer 14, and the second sealant layer 22 is an intermediate layer arranged between the first sealant layer 21 and the third sealant layer 33.

The sealant layer 20B of the battery packaging material 2 shown in FIG. 2 has a two-layer structure composed of a first sealant layer 21, which is the innermost layer, and a third sealant layer 23, which is closest to the barrier layer 11. The sealant layer 20C of the battery packaging material 3 shown in FIG. 3 is a single layer composed of a first sealant layer 21, which is the innermost layer.

In the present invention, the innermost layer is referred to as the first sealant layer 21, regardless of the number of layers of the sealant layer 20A, 20B, 20C. The first sealant 21 is an essential layer. In the sealing layers 20A and 20B consisting of two or more layers, the layer closest to the barrier layer 11 is referred to as the third sealant layer 23. In the sealant layer 20A consisting of three or more layers, all the layers between the first sealant layer 21 and the third sealant layer 23 are referred to as the second sealant layer 22. Therefore, in a sealant layer composed of four or more layers (not shown), the second sealant layer 22 is composed of two or more layers.

### (Material of First Sealant Layer)

The first sealant layer 21 is made of a resin blend of a polyolefin resin A having a melting point of 120° C. or above and a polyolefin resin B having a melting point of less than 120° C. By using two resin blends different in melting point, the seal strength can be maintained high at temperatures of 100° C. or below, and the polyolefin resin B having a lower melting point softens before the polyolefin resin A softens at temperatures 100° C. or above up to 130° C., thus the seal strength gradually reduces to gently unseal the seal portion of the battery case. This allows gradual gas discharging to prevent the case rupturing.

Furthermore, the polyolefin resin A and the polyolefin resin B described above are preferably compatible with each other, and the properties of the resins combined with each other can fully achieve the effects of maintaining a high sealing strength at temperatures of 100° C. or below, as well as gentle unsealing until it reaches 130° C. Note that the state in which the polyolefin resin A and the polyolefin resin B are compatible is a state in which they are compatible and in a uniform phase.

The preferred melting point of the polyolefin resin A is 125° C. to 145° C., particularly preferably 125° C. to 135° C. The preferred melting point of the polyolefin resin B is 80° C. to 115° C., particularly preferably 80° C. to 105° C. Furthermore, in order to suppress sudden unsealing, it is necessary that unsealing starts at a lower temperature and the resin does not melt completely until it reaches a certain higher temperature. Therefore, the difference in the melting point between the polyolefin resin A and the polyolefin resin B is preferably 10° C. or above.

As the polyolefin resin A, a propylene-ethylene random copolymer, a propylene-butene random copolymer, a propylene-ethylene-butene random copolymer, a propylene (metallocene-based propylene compound) prepared using a metallocene catalyst, and a propylene compound (metallocene-based propylene compound) prepared using a metallocene catalyst can be exemplified. Among them, it is preferred that at least one of them be contained.

Furthermore, as the polyolefin resin B, it is preferred to contain a propylene-ethylene copolymer and/or a propylene-α-olefin copolymer.

The polyolefin resins A and B may be in the form of elastomer or plastomer, and the use of a polyolefin-based plastomer as a resin has the effect of slightly lowering the melting point as well as enhancing flexibility and improving impact resistance. Since these resin combinations are highly compatible, they are suitable for obtaining the effect of maintaining the high sealing strength at temperatures of 100° C. or below as well as gradual unsealing until it reaches 130° C.

The mixing ratio (A:B) of the polyolefin resin A to the polyolefin resin B by mass is preferably 20:80 to 80:20, more preferably 30:70 to 60:40, and even more preferably to 50:50. By mixing two resins having different melting points within the above-described range, it is possible to fully achieve the effect of maintaining high sealing strength at temperatures of 100° C. or below as well as gentle unsealing until it reaches 130° C.

As for the above-described mixing ratio (A:B), the more the polyolefin resin A, the higher the seal strength can be maintained at temperatures of 100° C. or below, while the more polyolefin resin B, the lower the seal strength at temperature of 100° C. to 130° C. Therefore, in order to achieve gentle unsealing, it is preferable to blend the polyolefin resin B more than the polyolefin resin A. From this viewpoint, the mixing ratio (A:B) is preferably 30:70 to more preferably 30:70 to 40:60.

Further, although the sealant layer 21 may also contain resins other than the polyolefin resin A and the polyolefin resin B, the total content of the polyolefin resin A and the polyolefin resin B in the first sealant layer 21 is preferably in the range of 90 mass % to 99.9 mass %, particularly preferably in the range of 95 mass % to 99.8%. Note that the resin constituting the first sealant layer 21 is not limited to the polyolefin resin A and the polyolefin resin B exemplified above, but other polyolefin resins C having a melting point of 110° C. to 130° C. may be added. The above-described other polyolefin resins C can be added as needed in view of the melting points of the mixture of the polyolefin resin A and the polyolefin resin B.

As the polyolefin resin C, a polypropylene-ethylene elastomer (propylene-α-olefin copolymer) or the like can be exemplified.

(Materials of Sealant layer Composed of Three or More Layers)

In a case where the sealant layer 20A is composed of three or more layers, at least one layer of the second sealant layer 22 and the third sealant layer 23 are preferably made of a polyolefin resin having a melting point of 130° C. or above. By arranging a resin layer having a higher melting point outside the innermost first sealant layer 21, which comes into contact with each other during heat sealing, the case can be assuredly unsealed by peeling off at the first sealant layer 21 when the temperature is raised. Therefore, the unsealing timing can be precisely controlled to prevent the case rupturing. Furthermore, the presence of the second sealant layer 22 and the third sealant layer 23 having a higher melting point on the outer side can suppress the decrease in thickness of the sealant layer 20A due to heat sealing, thus making the sealant layer 20A thinner.

The particularly preferred melting point of the resin constituting the second sealant layer 22 is 135° C. or above, and the particularly preferred melting point of the resin constituting the third sealant layer 23 is 140° C. or above. Further, the melting point of the second sealant layer 22 is preferably lower than that of the third sealant layer 23.

As a polyolefin resin having a melting point of 130° C. or above constituting at least one layer of the second sealant layer 22, a propylene-ethylene random copolymer, a propylene-butene random copolymer, a propylene-butene random copolymer, a propylene-ethylene-butene random copolymer, a propylene (metallocene-based propylene) prepared using a metallocene catalyst, a propylene compound (a metallocene-based propylene compound) prepared using a metallocene catalyst, a propylene-ethylene block copolymer, a propylene-butene block copolymer, and a propylene-ethylene-butene block copolymer can be exemplified. A resin blend containing at least one of these resins can also be used. Among the above-described resins, the most preferred resins are a propylene-ethylene random copolymer, a propylene-butene random copolymer, and a propylene-ethylene-butene random copolymer.

As a polyolefin resin having a melting point of 130° C. or above constituting the third sealant layer 23, the same resin as the resin constituting at least one layer of the second sealant layer 22 described above and a propylene homopolymer can be exemplified. A resin blend containing at least one of these resins can also be used. Among the above-described resins, the most preferred resins are a propylene-ethylene random copolymer, a propylene-butene random copolymer, and a propylene-ethylene-butene random copolymer.

By using the above-described resin in the second sealant layer 22 and the third sealant layer 23, it becomes unlikely to occur delamination within the sealant layers, and the seal strength at 100° C. or below can be assuredly maintained.

Further, also in the two-layer structured sealant layer 20B shown in FIG. 2, the resin suitable for the third sealant layer 23 is similar to the resin constituting the third sealant layer 23 of the above-described three-layer structured sealant layer 20A.

Each layer of the above-described sealant layers 20A, 20B, and 20C may be blended with additives, such as, e.g., a lubricant and an anti-blocking agent, in addition to the resins described above. The lubricant and the anti-blocking agent have the effect of increasing slipperiness and improving moldability.

The lubricant is not particularly limited, but includes, for example, a saturated fatty amide, an unsaturated fatty acid amide, a substituted amide, a methylol amide, a saturated fatty acid bisamide, an unsaturated fatty acid bisamide, a fatty acid ester amide, an aromatic bisamide, and the like.

As the saturated fatty acid amide, a lauramide, a palmiticamide, a stearamide, a behenamide, and a hydroxystearamide can be exemplified.

As the unsaturated fatty acid amide, an oleamide and erucamide can be exemplified.

As the substituted amide, an N-oleoyl palmitamide, an N-stearyl stearamide, an N-stearyl oleamide, an N-oleoyl stearamide, and N-stearyl erucamide can be exemplified.

As the methylolamide, a methylol stearamide can be exemplified.

As the saturated fatty acid bisamide, a methylene bisstearamide, an ethylene biscaprinamide, an ethylene bislauramide, an ethylene bisstearamide, an ethylene bishydroxystearamide, an ethylene bisbehenamide, a hexamethylene bisstearamide, a hexamethylene bisbehenamide, a hexamethylene hydroxystearamide, an N,N′-distearyl adipamide, and an N,N′-distearyl sebacinamide can be exemplified.

As the unsaturated fatty acid bisamide, an ethylene a bisoleamide, an ethylene biserucamide, a hexamethylene bisoleicamide, an N,N′-dioleoyl adipipamide, and an N,N′-dioleoyl sebacinamide can be exemplified.

As the fatty acid ester amide, stearamide ethyl stearate can be exemplified.

As the aromatic-based bisamide, an m-xylylene bis-stearamide, an m-xylylene bis-hydroxystearamide, and an N,N′-distearylisophthalamide can be exemplified

The anti-blocking agent is not specifically limited, but includes, for example, particles of silica, acrylic resin, aluminum silicate, calcium carbonate, barium carbonate, titanium dioxide, talc, kaolin, etc.

The preferred concentrations of the various additives in the sealant layers 20A, 20B, and 20C described above are as follows. The lubricant concentration is 100 ppm to 3,000 ppm, and the anti-blocking agent concentration is 100 ppm to 5,000 ppm.

The thickness of the sealant layer 20A, 20B, 20C is preferably 20 μm to 100 μm in total thickness (T), more preferably 20 μm to 80 μm in total thickness. It is even more preferable that the total thickness be 25 μm to 50 μm. In the two-layer structured sealant layer 20B composed of the first sealant layer 21 and the third sealant layer 23, it is preferable that the ratio t1:t3 of the thickness of the first sealant layer 21 (t1) to the thickness (t3) of the third sealant layer 23 when the total thickness (T) is 10 be distributed 2-8 to 8-2, more preferably 4-8 to 6-2. Furthermore, in the three-layer structured sealant layer 20B composed of the first sealant layer 21, the second sealant layer 22, and the third sealant layer 23, it is preferable that the ratio t1:t2:t3 of the thicknesses (t1) of the first sealant layer 21, the thickness (t2) of the second sealant layer 22, and the thickness (t3) of the third sealant layer 23 when the total thickness (T) is 10 be distributed as 1-4: 2-7:1-7, more preferably 2-4: 2-4:3-6.

### [Layer Other Than Sealant Layer of Battery Packaging Material]

In the battery packaging material of the present invention, any well-known material can be used for layers other than the sealant layer, and the lamination method is not particularly limited. Hereinafter, suitable materials for the layers other than the sealant layer will be described.

### (Substrate Layer)

As the substrate layer 13, a heat-resistant resin film that does not melt at the heat-sealing temperature when heat-sealing the battery packaging material 1, 2, 3 is used. As the heat-resistant resin, a heat-resistant resin having a melting point higher than the melting point of the resin constituting the sealant layers 20A, 20B, 20C by 10° C. or above, preferably 20° C. or above, is used. As a resin satisfying these conditions, for example, a polyamide film such as a nylon film, a polyester film, etc., can be exemplified, and these stretched films are preferably used. Among them, as the substrate layer 13, it is particularly preferable to use a biaxially stretched polyamide film, such as, e.g., a biaxially stretched nylon film, a biaxially stretched polybutylene terephthalate (PBT) film, a biaxially stretched polyethylene terephthalate (PET) film, or a biaxially stretched polyethylene naphthalate (PEN) film.

As the above-described nylon film, although not particularly limited, a 6-nylon film, a 6,6-nylon film, an MXD nylon film, etc., are exemplified. Note that the substrate layer 13 may be formed as a single layer, or may be formed as a multiple layer consisting of, for example, a polyester/a polyamide film (such as a multiple layer consisting of a PET film/a nylon film).

The thickness of the substrate layer 13 is preferably 9 μm to 50 μm, which can ensure a sufficient strength as a packaging material and can reduce stress during molding, such as, e.g., tension molding and drawing molding, which can improve the formability. The more preferred thickness of the substrate layer 13 is 12 μm to 30 μm.

### (Barrier Layer)

The barrier layer 11 is responsible for providing the battery packaging materials 1, 2, 3 with gas barrier properties that prevent intrusion of oxygen and moisture. As the barrier layer 11, although not particularly limited, a metal foil, such as, e.g., an aluminum foil, a SUS foil (stainless steel foil), a copper foil, a nickel foil, a titanium foil, and a clad foil, may be used. The thickness of the barrier layer 11 is preferably 20 μm to 100 μm. A thickness of 20 μm or more prevents the formation of pinholes during rolling when producing a metal foil, and a thickness of 100 μm or less reduces the stress during molding, such as, e.g., tension molding and drawing molding, thereby improving the moldability of the metal foil. The particularly preferred thickness of the barrier layer 11 is 30 μm to 80 μm.

Furthermore, it is preferable that the barrier layer 11 be subjected to surface preparation, such as, e.g., a chemical conversion treatment, on at least the surface of the metal foil on the sealant layer 20A, 20B, 20c side. This chemical conversion treatment sufficiently prevents corrosion of the metal foil surface due to contents (e.g., battery electrolyte).

For example, the metal foil is subjected to a chemical conversion treatment by the following processing.

One of the following aqueous solutions 1) to 3) is applied to a degreased surface of a metal foil and then dried, thereby undergoing a chemical conversion treatment.
(1) an aqueous solution of a mixture containing phosphoric acid, chromic acid, and at least one compound selected from the group consisting of metal salts of fluorides and non-metal salts of fluorides
(2) an aqueous solution of a mixture containing phosphoric acid, at least one resin selected from the group consisting of an acrylic-based resin, a chitosan derivative resin, and a phenol-based resin, and at least one compound selected from the group consisting of chromic acid and chromium (III) salt.
(3) a solution of a mixture containing phosphoric acid, at least one resin selected from the group consisting of an acrylic-based resin, a chitosan derivative resin and a phenol-based resin, at least one compound selected from the group consisting of metal salts of fluoride and non-metal salts of fluoride metal.

As for the chemical conversion coating, the chrome adhesion amount (per one side) is preferably 0.1 mg/m² to 50 mg/m², particularly from 2 mg/m² to 20 mg/m².

### (First Adhesive Layer)

As the first adhesive layer 12, although not particularly limited, an adhesive layer formed by, e.g., a two-part curing type adhesive can be exemplified. As the two-part curing type adhesive, for example, a first liquid (main agent) composed of one or more polyols selected from the group consisting of a polyurethane-based polyol, a polyester-based polyol, a polyether-based polyol, and a polyester urethane-based polyol, and a second liquid composed of an isocyanate (hardener) is exemplified. Among them, it is preferable to use a two-part curing type adhesive composed of a first liquid composed of one or more polyols selected from the group consisting of a polyester-based polyol and a polyester urethane-based polyol and a second liquid (curing agent) composed of an isocyanate. The preferred thickness of the first adhesive layer 12 is 1 μm to 5 μm.

### (Second Adhesive Layer)

As the second adhesive layer 14, although not particularly limited, in the case of a dry lamination method, for example, an adhesive containing one or more of a polyurethane-based resin, an acrylic-based resin, an epoxy-based resin, a polyolefin-based resin, an elastomer-based resin, a fluorine-based resin, and an acid modified polyolefin resin, is recommended. Among them, an adhesive composed of a polyurethane composite resin with an acid-modified polyolefin as a main ingredient is preferred. Furthermore, in the case of a sand lamination method or a thermal lamination method, a modified polyolefin resin, such as, e.g., an acid-modified polypropylene-based resin or an acid-modified polyethylene-based resin, can be recommended. The preferred thickness of the second adhesive layer 14 depends on the lamination method and is preferably 2 μm to 5 μm in the case of a dry lamination method, and 2 μm to 20 μm in the case of a sand lamination method or a thermal lamination method.

### (Other Lamination Configurations of Battery Packaging Material)

In the battery packaging material of the present invention, the first adhesive layer and the second adhesive are not essential layers, and the substrate layer may be directly bonded to the barrier layer, or the sealant layer may be directly bonded to the barrier layer.

Further, in the battery packaging material of the present invention, another layer can be formed on the outer side of the substrate layer, so that the outer layer is composed of a plurality of layers including the substrate layer. As a layer to be formed on the outside of the substrate layer, a protective layer and a matte coat layer can be exemplified. These layers serve as the outermost layer of the battery packaging material to protect the substrate layer and provide good surface slipperiness to enhance formability.

As a material for the protective layer, a phenoxy-based resin, a urethane-based resin, an epoxy-based resin, an acrylic-based resin, a polyolefin-based resin, or a fluorine-based resin can be recommended. Further, the matte coat layer is made of a resin composition prepared by blending a resin with a matting agent. As the matting agent, inorganic particulates of silica, alumina, calcium oxide, calcium carbonate, calcium sulfate, calcium silicate, and resin beads such as acrylic beads can be recommended.

### EXAMPLES

Battery packaging materials of Examples 1 to 23 and Comparative Examples 1 to 5 were prepared. In these battery packaging materials, as referenced in the battery packaging materials 1, 2, 3 shown in FIG. 1 to FIG. 3, the substrate layer 13 was laminated to one surface of the barrier layer 11 via a first adhesive layer 12, and a sealant layer 20A, 20B, was laminated to the other surface of the barrier layer 11 via the second adhesive layer 14. The battery packaging materials described above are common in the barrier layer 11, the substrate layer 13, the first adhesive layer 12, and the second adhesive layer 14 and differ in the layer configuration and the material of the sealant layer 20A, 20B, The sealant layers 20C of the battery packaging material in Examples 1 and 2 were composed of a single layered of the first sealant layer 21 (see FIG. 3). The sealant layers 20B in Example 3 and Comparative Example 1 were composed of two layers of the first sealant layer 21 and the third sealant layer 23 (see FIG. 2). The sealant layers 20A in Examples 4-23 and Comparative Examples 2-5 were composed of three layers of the first sealant layer 21, the second sealant layer 22, and the third sealant layer 23 (see FIG. 1).

For the battery packaging materials in each Example, a sealant layer film composed of a single or multiple layer film was prepared using the materials and the method described below, and the sealant layer film was laminated on the laminate of the substrate layer, the first adhesive layer, and the barrier layer prepared by the common material of each Example via the second adhesive. The details of the sealant layer film and the production method of the battery packaging material for each Example are as follows.

### [Sealant Layer Film for Each Example]

### Examples 1 and 2

The polyolefin resin A and the polyolefin resin B shown in the column for the first sealant layer in Table 1 were mixed in the mass ratios shown in Table 1 to be compatible. A resin composition was prepared by blending the above-described resin blend with erucamide of 1,000 ppm as a lubricant and silica particles of 2,000 ppm as an anti-blocking agent. The above-described resin composition was extruded using a T-die to produce a single-layer sealant layer film having a thickness of 30 μm.

### Example 3

The polyolefin resin A and the polyolefin resin B shown in the column for the first sealant layer in Table 1 were mixed in the mass ratios shown in Table 1 to be compatible. The above-described resin blend was blended with erucamide of 1,000 ppm as a lubricant and silica particles of 2,000 ppm as an anti-blocking agent to prepare a resin composition for the first sealant layer.

The resin composition for the third sealant layer was prepared by blending the resin shown in the column for the third sealant layer in Table 1 with erucamide of 1,000 ppm as a lubricant and silica particles of 2,000 ppm as an anti-blocking agent.

The resin composition for the first sealant and the resin composition for the third sealant layer were co-extruded using a T-die to produce a two-layer film for the sealant layer in which a first sealant layer 21 having a thickness of 18 μm and a third sealant layer 23 having a thickness of 12 μm were laminated together.

### Examples 4-7, 13, 14, 16-23

The polyolefin resin A and the polyolefin resin B shown in the column for the first sealant layer in Table 1 were mixed in the mass ratios shown in Table 1 to be compatible. The above-described resin blend was blended with erucamide of 1,000 ppm as a lubricant and silica particles of 2,000 ppm as an anti-blocking agent to prepare the resin composition for the first sealant layer.

A resin composition for the second sealant layer was prepared by blending the resin shown in the column for the second sealant layer in Table 1 with erucamide of 1,000 ppm as a lubricant.

A resin composition for the third sealant layer was prepared by blending the resin shown in the column for the third sealant layer in Table 1 with erucamide of 1,000 ppm as a lubricant and silica particles of 2,000 ppm as an anti-blocking agent.

The resin composition for the first sealant, the resin composition for the second sealant layer, and the resin composition for the third sealant layer were co-extruded using a T-die to produce a three-layer sealant layer in which the first sealant layer 21 having a thickness of 9 μm, the second sealant layer 22 having a thickness of 9 μm, and the third sealant layer 23 having a thickness of 12 μm were laminated.

### Examples 8-12, 15

A resin blend for the first sealant layer was prepared by blending the polyolefin resin A, the polyolefin resin B, and the polyolefin resin C shown in the column for the first sealant layer in Table 1 to be compatible, with erucamide of 1,000 ppm as a lubricant and silica particles of 2,000 ppm as an anti-blocking agent. In Table I, the mass ratio of the polyolefin resin A to the polyolefin resin B, the ratio of the total amount of the polyolefin resin A and the polyolefin resin B to the total amount of resins, and the ratio of the polyolefin resin C to the total amount of resins, in the above-described resin compositions are shown.

A resin composition for the second sealant layer was prepared by blending the resin shown in the column for the second sealant layer in Table 1 with erucamide of 1,000 ppm as a lubricant.

A resin composition for the third sealant layer was prepared by blending the resin shown in the column for the third sealant layer in Table 1 with erucamide of 1,000 ppm as a lubricant and silica particles of 2,000 ppm as an anti-blocking agent.

The resin composition for the first sealant, the resin composition for the second sealant layer, and the resin composition for the third sealant layer were co-extruded using a T-die to produce a three-layer sealant layer in which the first sealant layer 21 having a thickness of 9 μm, the second sealant layer 22 having a thickness of 9 μm, and the third sealant layer 23 having a thickness of 12 μm were laminated.

### Comparative Example 1

A resin composition for the first sealant layer was prepared by blending the polyolefin resin A shown in the column for the first sealant layer in Table 1 with erucamide of 1,000 ppm as a lubricant and silica particles of 2,000 ppm as an anti-blocking agent.

A resin composition for the third sealant layer was prepared by blending the resin shown in the column for the third sealant layer in Table 1 with erucamide of 1,000 ppm as a lubricant and silica particles of 2,000 ppm as an anti-blocking agent.

The resin composition for the first sealant and the resin composition for the third sealant layer were co-extruded using a T-die to produce a two-layer sealant layer film in which the first sealant layer 21 having a thickness of 20 μm and the third sealant layer 23 having a thickness of 10 μm were laminated.

### Comparative Examples 2-5

A three-layered sealant layer film was prepared in the same way as in Example 4, except that the resins shown in Table 1 were used as the resin for the first sealant layer, the resin for the second sealant layer, and the resin for the third sealant layer.

Table 1 below outlines the sealant layer for each Example.

The abbreviations of the resins listed in Table 1 are as follows:
mPP: Metallocene-based polypropylene
ER: Polypropylene-ethylene elastomer (propylene-α-olefin copolymer)
PE: Propylene-ethylene copolymer
bPP: Propylene-ethylene block copolymer
rPP: Propylene-ethylene random copolymer
rPB: Propylene-butene random copolymer
rPEB: Propylene-ethylene-butene random copolymer

Further, the melting point of each resin was determined by differential scanning calorimetry (DSC) at a temperature increase rate of 10° C./min in accordance with JIS K7121, and the peak temperature was denoted as Tpm.

### [Production Method of Battery Packaging Material]

As the barrier layer 11, a chemical conversion treatment solution composed of polyacrylic acid (acrylic-based resin), a chromium (III) salt compound, water, and alcohol was applied to both surfaces of an aluminum foil made of A8079 having a thickness of 40 μm, and then dried at 150° C. to form a chemical conversion film. The chromium adhesion amount of this chemical conversion coating was 5 mg/m² per side. Further, as the substrate layer 13, a biaxially stretched nylon 6 film having a thickness of 15 μm was used.

A two-part curing type urethane-based adhesive was applied to one surface of the above-described barrier layer 11 to form a first adhesive layer 12 having a thickness of 3 μm, and the substrate layer 13 was dry-laminated. Next, a two-part curing type maleic acid modified propylene adhesive was applied to the other surface of the above-described barrier layer 11 to form a second adhesive layer 14 having a thickness of 2 μm, and the film for the sealant layer was dry-laminated. At this time, lamination was performed such that the first sealant layer 21 contacts the second adhesive layer 14 in the case of a single-layer sealant layer film, and the third sealant layer 23 contacts the second adhesive layer 14 in the case of a two- or three-layer sealant layer film.

Then, the laminate sheet with all layers laminated together was sandwiched and pinched between a rubber nip roll and a laminating roll heated to 100° C. to complete dry lamination, followed by aging (heating) at 40° C. for 10 days to obtain a battery packaging material 1, 2, 3.

### [Evaluation of Battery Packaging Material]

The following items were measured and evaluated for each Example of the prepared battery packaging material 1, 2, 3. The results are shown in Table 1.

### (Seal Strength)

A plurality of test pieces of the battery packaging material 1, 2, 3 were prepared by cutting it into pieces of mm in width×150 mm in length. Two sheets of the above-described test pieces were stacked so that the sealant layers 20B, and 20C faced each other, and heat-sealed using a heat-sealing device (TP-701-A, manufactured by Tester Sangyo Co.) by one surface heating under the conditions of heat seal temperature: 180° C., seal pressure: 0.3 MPa (gauge indication pressure), and seal time: 4 seconds to prepare a test piece for seal strength. Three test pieces were prepared for each Example for the test piece for measuring the seal strength.

Three test pieces for the seal strength measurement were allowed to stand for 24 hours at three different temperatures (25° C., 100° C., and 130° C.), and then the seal strength was measured at each of these temperatures.

The seal strength was measured in accordance with JIS Z0238-1998, using a Shimadzu Astrograph (AGS-5kNX) as a tensile testing machine. The end of one test piece was clamped and fixed with one chuck of the above-described tensile testing machine, and the other end of the test piece was grabbed with the other chuck, and the peel strength was measured when the test piece was T-peeled at a tensile speed of 100 mm/min, which was defined as the seal strength (N/15 mm).

### (Unsealing Test)

The battery packaging material 1, 2, 3 was cut into rectangular test pieces of 100 mm in width×200 mm in length. The rectangular test piece was folded in half at the center of the longitudinal direction with the sealant layers 20A, 20B, and 20C inside, and the two sides following the folded mountain were heated on one side under the following conditions: seal width: 5 mm, heat seal temperature: 180° C., seal pressure: 0.3 MPa (gauge pressure), seal time: 4 seconds. The opposite sides of the fold peak was opened to form a bag. Next, 2.0 g of water was added through the opening of the bag, and the bag was sealed by heat-sealing the opening edge under the same conditions as the other two edges, and used as the test piece for the unsealing test.

The above-described test piece for unsealing tests was placed in an oven and heated from 25° C. to 130° C. at a rate of 5° C./min. After reaching 130° C., the test piece was held at 130° C. for 30 minutes, and the unsealing state was observed from the temperature increase until the 130° C.×30 minutes holding period was completed and evaluated using the following criteria.
A: It was unsealed during the temperature increase to 100° C.-130° C., and the gas was gradually released.
B: It was not unsealed during the temperature rise to 130° C. but was unsealed during the holding at 130° C., and the gas was gradually released.
C: It was unsealed during the temperature increase to 100° C.-130° C., and the gas was rapidly released.
D: It was not unsealed during the temperature increase to 130° C., and the gas was suddenly released during holding at 130° C.
X: It was not unsealed even while being held at 130° C.
Y: It was unsealed during the temperature rise to 100° C.

Note that this test was based on the external heating test (JIS C8714), but the JIS C8714 requires a holding time of 130° C. for 10 minutes after reaching 130° C., while this test set the holding time at 130° C. for 30 minutes, which was a more severe condition.

TABLE 1

| | | First sealant layer | | | | | | | | | |
|---|---|---|---|---|---|---|---|---|---|---|---|
| | | Polyolefin | | Polyolefin | | Polyolefin | | | | | |
| | | resin A | | resin B | | resin C | | | A + B | C | |
| | | | Melting | | Melting | | Melting | | content rate | content rate | Thickness |
| | | Resin | point ° C. | Resin | point ° C. | Resin | point ° C. | A:B | % | % | μm |
| Example | 1 | mPP | 125 | ER | 82 | — | — | 40:60 | 99.7 | — | 30 |
| | 2 | rPP | 132 | ER | 82 | — | — | 30:70 | 99.7 | — | 30 |
| | 3 | mPP | 125 | ER | 82 | — | — | 40:60 | 99.7 | — | 18 |
| | 4 | mPP | 125 | ER | 82 | — | — | 40:60 | 99.7 | — | 9 |
| | 5 | mPP | 125 | ER | 82 | — | — | 20:80 | 99.7 | — | 9 |
| | 6 | mPP | 125 | ER | 82 | — | — | 70:30 | 99.7 | — | 9 |
| | 7 | mPP | 125 | ER | 82 | — | — | 50:50 | 99.7 | — | 9 |
| | 8 | mPP | 125 | ER | 82 | ER | 120 | 40:60 | 94.5 | 5.2 | 9 |
| | 9 | mPP | 125 | ER | 82 | ER | 120 | 40:60 | 90 | 9.7 | 9 |
| | 10 | mPP | 125 | ER | 82 | ER | 120 | 40:60 | 85.5 | 14.2 | 9 |
| | 11 | mPP | 125 | ER | 82 | ER | 105 | 40:60 | 95 | 4.7 | 9 |
| | 12 | mPP | 125 | ER | 82 | ER | 105 | 40:60 | 90.5 | 9.2 | 9 |
| | 13 | rPP | 138 | ER | 82 | — | — | 40:60 | 99.7 | — | 9 |
| | 14 | rPP | 132 | PE | 95 | — | — | 40:60 | 99.7 | — | 9 |
| | 15 | rPP | 132 | PE | 95 | ER | 120 | 40:60 | 94.5 | 5.2 | 9 |
| | 16 | rPP | 132 | ER | 107 | — | — | 40:60 | 99.7 | — | 9 |
| | 17 | rPEB | 135 | ER | 107 | — | — | 40:60 | 94.5 | — | 9 |
| | 18 | xPP | 132 | ER | 76 | — | — | 40:60 | 99.7 | — | 9 |
| | 19 | mPP | 125 | ER | 82 | — | — | 40:60 | 99.7 | — | 9 |
| | 20 | mPP | 125 | ER | 82 | — | — | 40:60 | 99.7 | — | 9 |
| | 21 | mPP | 125 | ER | 82 | — | — | 40:60 | 99.7 | — | 9 |
| | 22 | mPP | 125 | ER | 82 | — | — | 40:60 | 99.7 | — | 9 |
| | 23 | ER | 120 | ER | 105 | — | — | 40:60 | 99.7 | — | 9 |
| Comp. | 1 | ER | 115 | — | — | — | — | — | 99.7 | — | 20 |
| Ex. | 2 | ER | 115 | — | — | — | — | — | 99.7 | — | 9 |
| | 3 | mPP | 125 | ER | 120 | — | — | 40:60 | 99.7 | — | 9 |
| | 4 | rPP | 142 | — | — | — | — | — | 99.7 | — | 9 |
| | 5 | — | — | ER | 82 | — | — | — | 99.7 | — | 9 |

| | | | | | | | | Evaluation | | | |
|---|---|---|---|---|---|---|---|---|---|---|---|
| | | Second sealant layer | | | Third sealant layer | | | Seal strength | | | |
| | | | Melting | Thickness | | Melting | Thickness | N/ 15 mm | | | Unsealing |
| | | Resin | point ° C. | μm | Resin | point ° C. | μm | 25° C. | 100° C. | 130° C. | test |
| Example | 1 | — | — | — | — | — | — | 85 | 46 | 2 | A |
| | 2 | — | — | — | — | — | — | 84 | 41 | 3 | A |
| | 3 | — | — | — | rPP | 160 | 12 | 85 | 45 | 2 | A |
| | 4 | bPP | 142 | 9 | rPP | 160 | 12 | 85 | 45 | 2 | A |
| | 5 | bPP | 142 | 9 | rPP | 160 | 12 | 79 | 36 | 1 | A |
| | 6 | bPP | 142 | 9 | rPP | 160 | 12 | 91 | 48 | 3 | A |
| | 7 | bPP | 142 | 9 | rPP | 160 | 12 | 90 | 46 | 2 | A |
| | 8 | bPP | 142 | 9 | rPP | 160 | 12 | 85 | 44 | 2 | A |
| | 9 | bPP | 142 | 9 | rPP | 160 | 12 | 84 | 43 | 2 | A |
| | 10 | bPP | 142 | 9 | rPP | 160 | 12 | 83 | 41 | 2 | A |
| | 11 | bPP | 142 | 9 | rPP | 160 | 12 | 86 | 39 | 2 | A |
| | 12 | bPP | 142 | 9 | rPP | 160 | 12 | 85 | 37 | 2 | A |
| | 13 | bPP | 142 | 9 | rPP | 160 | 12 | 91 | 48 | 4 | B |
| | 14 | bPP | 142 | 9 | rPP | 160 | 12 | 85 | 50 | 5 | B |
| | 15 | bPP | 142 | 9 | rPP | 160 | 12 | 85 | 47 | 5 | B |
| | 16 | bPP | 142 | 9 | rPP | 160 | 12 | 85 | 50 | 7 | B |
| | 17 | bPP | 142 | 9 | rPP | 160 | 12 | 85 | 50 | 7 | B |
| | 18 | bPP | 142 | 9 | rPP | 160 | 12 | 81 | 35 | 1 | A |
| | 19 | mPP | 125 | 9 | rPP | 160 | 12 | 86 | 45 | 2 | A |
| | 20 | bPP | 142 | 9 | rPP | 160 | 12 | 86 | 45 | 2 | A |
| | 21 | bPP | 155 | 9 | rPP | 160 | 12 | 85 | 45 | 2 | A |
| | 22 | bPP | 142 | 9 | rPP | 142 | 12 | 85 | 46 | 2 | A |
| | 23 | bPP | 142 | 9 | rPP | 142 | 12 | 75 | 42 | 1 | A |
| Comp. | 1 | — | — | — | rPP | 136 | 10 | 50 | 32 | 1 | C |
| Ex. | 2 | bPP | 142 | 9 | rPP | 160 | 12 | 50 | 33 | 1 | C |
| | 3 | bPP | 142 | 9 | rPP | 160 | 12 | 85 | 50 | 20 | X |
| | 4 | bPP | 142 | 9 | rPP | 160 | 12 | 95 | 60 | 45 | X |
| | 5 | bPP | 142 | 9 | rPP | 160 | 12 | 40 | 7 | 1 | Y |

From the results in Table 1, it was confirmed that the battery packaging materials of Examples maintained high seal strength at temperatures of 100° C. or below, and that the seal strength was gradually reduced at temperatures of 100° C.-130° C., resulting in gradual unsealing.

In particular, by setting the mixing ratio (A:B) of the polyolefin resin A to the polyolefin resin B to 30:70 to and using polypropylene (metallocene-based polypropylene) using a metallocene-based catalyst as the polyolefin resin A, the seal strength at 25° C. became 80 N/15 mm or more, and the seal strength at 100° C. became 37 N/15 mm to 46 N/15 mm. The seal did not excessively function and gradually started unsealing, and the seal strength at 130° C. became 3 N/15 mm or less, which could obtain a seal strength that ensures assured unsealing at 130° C.

### INDUSTRIAL APPLICABILITY

The battery packaging material of the present invention can be suitably used as a packaging material for a secondary battery for use in an automotive, a stationary computer, a laptop computer, a cell phone, and a camera, especially suitably used as a packaging material for a small portable lithium-ion secondary battery.

This application claims priority to Japanese Patent Application No. 2022-100857, filed on Jun. 23, 2022, and Japanese Patent Application No. 2023-80761, filed on May 16, 2023, the disclosure of which is incorporated herein by reference, and the disclosure thereof constitutes a part of this application as it is.

It must be recognized that the terms and expressions used herein are for illustrative purposes only, not intended to be interpreted in a limiting manner, do not exclude any equivalents of the features shown and described herein, and allow for various variations within the claimed scope of this invention. It must be recognized that the invention does not exclude any equivalents of the features shown and described herein, but permits various variations within the claimed scope.

Description of Reference Symbols
1 . . . Battery packaging material
11 . . . Barrier layer
12 . . . First adhesive layer
13 . . . Substrate layer
14 . . . Second adhesive layer
20A, 20B, 20C . . . Sealant layer
21 . . . First sealant layer
22 . . . Second sealant layer
23 . . . Third sealant layer

1. A battery packaging material comprising:
a substrate layer served as an outer layer;
a sealant layer served as an inner layer;
a barrier layer arranged between the substrate layer and the sealant layer,
wherein the sealant layer is composed of one or more layers, and
wherein a first sealant layer served as an innermost layer is made of a resin blend containing a polyolefin resin A having a melting point of 120° C. or above and a polyolefin resin B having a melting point of less than 120° C.

2. The battery packaging material as recited in claim 1,
wherein in the resin blend, the polyolefin resin A and the polyolefin resin B are compatible with each other.

3. The battery packaging material as recited in claim 1,
wherein the polyolefin resin A contains at least one of a propylene-ethylene random copolymer, a propylene-butene random copolymer, a propylene-ethylene-butene random copolymer, a propylene (metallocene-based propylene) prepared using a metallocene catalyst, and a propylene compound (metallocene-based propylene compound) prepared using a metallocene catalyst, and
wherein the polyolefin resin B contains at least one of a propylene-ethylene copolymer and a propylene-α-olefin copolymer.

4. The battery packaging material as recited in claim 1,
wherein the sealant layer is a multiple layer composed of the first sealant layer, a second sealant layer composed of at least one layer or more, and a third sealant layer in sequence from an inner side of the battery packaging material toward the barrier layer, and
wherein the at least one layer of the second sealant layer and the third sealant layer are made of a polyolefin resin having a melting point of 130° C. or above.

5. The battery packaging material as recited in claim 4,
wherein the polyolefin resin having a melting point of 130° C. or above contains at least one of a propylene-ethylene random copolymer, a propylene-butene random copolymer, and a propylene-ethylene-butene random copolymer.

6. The battery packaging material as recited in claim 1,
wherein a total amount of the polyolefin resin A and the polyolefin resin B in the first sealant layer is 90 mass % to 99.9 mass % of a resin constituting the first sealant layer, and
wherein a mass ratio of the polyolefin resin A to the polyolefin resin B is 20:80 to 80:20.

7. The battery packaging material as recited in claim 1,
wherein a total amount of the polyolefin resin A and the polyolefin resin B in the first sealant layer is 90 mass % to 99.9 mass % of a resin constituting the first sealant layer, and
wherein a mass ratio of the polyolefin resin A to the polyolefin resin B is 30:70 to 50:50.

8. The battery packaging material as recited in claim 7,
wherein the polyolefin resin A contains polypropylene (metallocene-based propylene) using a metallocene catalyst.

9. The battery packaging material as recited in claim 2,
wherein the polyolefin resin A contains at least one of a propylene-ethylene random copolymer, a propylene-butene random copolymer, a propylene-ethylene-butene random copolymer, a propylene (metallocene-based propylene) prepared using a metallocene catalyst, and a propylene compound (metallocene-based propylene compound) prepared using a metallocene catalyst, and
wherein the polyolefin resin B contains at least one of a propylene-ethylene copolymer and a propylene-α-olefin copolymer.

10. The battery packaging material as recited in claim 2,
wherein the sealant layer is a multiple layer composed of the first sealant layer, a second sealant layer composed of at least one layer or more, and a third sealant layer in sequence from an inner side of the battery packaging material toward the barrier layer, and
wherein the at least one layer of the second sealant layer and the third sealant layer are made of a polyolefin resin having a melting point of 130° C. or above.

11. The battery packaging material as recited in claim 2,
wherein a total amount of the polyolefin resin A and the polyolefin resin B in the first sealant layer is 90 mass % to 99.9 mass % of a resin constituting the first sealant layer, and
wherein a mass ratio of the polyolefin resin A to the polyolefin resin B is 20:80 to 80:20.

12. The battery packaging material as recited in claim 2,
wherein a total amount of the polyolefin resin A and the polyolefin resin B in the first sealant layer is 90 mass % to 99.9 mass % of a resin constituting the first sealant layer, and
wherein a mass ratio of the polyolefin resin A to the polyolefin resin B is 30:70 to 50:50.
